(19) United States
(12) Patent Application Publication
(10) Pub. No.: US 2022/0261644 A1
(43) Pub. Date: Aug. 18, 2022

(54) METHOD AND APPARATUS FOR GENERATING TASK PLAN BASED ON NEURAL NETWORK

(71) Applicant: ELECTRONICS AND TELECOMMUNICATIONS RESEARCH INSTITUTE, Daejeon (KR)

(72) Inventor: Joonmyun CHO, Daejeon (KR)

(21) Appl. No.: 17/671,134

(22) Filed: Feb. 14, 2022

(30) Foreign Application Priority Data
Feb. 15, 2021 (KR) 10-2021-0019976

(51) Int. Cl. G06N 3/08; G06Q 10/06

(52) U.S. Cl. CPC G06N 3/08; G06Q 10/06316

(57) ABSTRACT

Provided are a method and an apparatus for generating a task plan. A method of generating a task plan for performing an arbitrary task includes generating a search tree based on a plurality of task states of the task and a plurality of task actions for performing the task, estimating a recommended path for an internal connection of the search tree by inputting the plurality of task states and the plurality of task actions to a neural network based on the search tree, and generating the task plan by determining a target path that reaches from an initial state of the task to a target state of the task based on the recommended path.

### CROSS-REFERENCE TO RELATED APPLICATION

This application claims the benefit of Korean Patent Application No. 10-2021-0019976 filed on Feb. 15, 2021, in the Korean Intellectual Property Office, the entire disclosure of which is incorporated herein by reference for all purposes.

### BACKGROUND

### 1. Field of the Invention

One or more example embodiments relate to a method and apparatus for generating a task plan based on a neural network.

### 2. Description of the Related Art

An autonomous thing such as an intelligent robot, an autonomous vehicle, and the like refers to equipment, a device or a system that performs a given task by itself without intervention of human according to current circumstances.

Various methods of implementing an autonomous thing may include a method of automatically generating a task plan and performing a given task based on the generated task plan. The task plan may be a sequence of actions that need to be performed to achieve (i.e., succeed) the given task.

Here, an action refers to a unit operation for an environment of the autonomous thing that changes a state of an environment. The achievement (success) of the task indicates that an autonomous thing changes a current state of an environment to a target state defined by the task, by performing a series of actions.

In the method of performing the task based on the task plan, information associated with the environment, the task and the action is expressed by symbols, and a symbolic logical operation is used in generating a task plan. The above method of performing the task may be referred to as a “symbolic automated planning technology”.

### SUMMARY

Example embodiments provide a technology of generating a task plan based on a neural network.

The technical aspects are not limited to the foregoing, and there may be other technical aspects.

Example embodiments provide a method of generating a task plan for performing an arbitrary task. According to an aspect, there is provided a method of generating a task plan, the method including generating a search tree based on a plurality of task states of the task and a plurality of task actions for performing the task, estimating a recommended path for an internal connection of the search tree by inputting the plurality of task states and the plurality of task actions to a neural network based on the search tree, and generating the task plan by determining a target path that reaches from an initial state of the task to a target state of the task based on the recommended path.

The generating of the search tree may include generating nodes corresponding to the plurality of task states, and generating the search tree by connecting the nodes via edges corresponding to the plurality of task actions.

The estimating of the recommended path may include generating a trained neural network by training the neural network based on the plurality of task states and the plurality of task actions, and estimating the recommended path based on the trained neural network.

The generating of the trained neural network may include generating a temporary task plan based on a heuristics, and generating the trained neural network by training the neural network based on the temporary task plan, the plurality of task states, and the plurality of task actions.

The estimating of the recommended path may include generating sequence data based on the plurality of task states, the plurality of task actions, and the task, and generating training data of the neural network by converting the sequence data.

The generating of the training data may include acquiring a hash code by performing a hash operation on a task state of the sequence data, generating an information vector by encoding a task action and a task of the sequence data, and generating the training data based on the hash code and the information vector.

The generating of the information vector may include acquiring a one-hot vector as the information vector by performing one-hot encoding on the task action and the task.

The generating of the task plan may include determining an edge connected to a front node in the search tree based on the recommended path, and determining a child node connected to the edge based on the edge.

The determining of the edge may include determining a recommended action type among the plurality of task actions based on the recommended path, and determining the edge based on the recommended action type.

According to another aspect, there is provided an apparatus for generating a task plan for performing an arbitrary task, the apparatus including a processor configured to generate a search tree based on a plurality of task states of the task and a plurality of task actions for performing the task, estimate a recommended path for an internal connection of the search tree by inputting the plurality of task states and the plurality of task actions to a neural network based on the search tree, and generate the task plan by determining a target path that reaches from an initial state of the task to a target state of the task based on the recommended path, and a memory configured to store an instruction that is executable by the processor.

The processor may generate nodes corresponding to the plurality of task states, and generate the search tree by connecting the nodes via edges corresponding to the plurality of task actions.

The processor may generate a trained neural network by training the neural network based on the plurality of task states and the plurality of task actions, and estimate the recommended path based on the trained neural network.

The processor may generate a temporary task plan based on a heuristics, and generate the trained neural network by training the neural network based on the temporary task plan, the plurality of task states, and the plurality of task actions.

The processor may generate sequence data based on the plurality of task states, the plurality of task actions, and the task, and generate training data of the neural network by converting the sequence data.

The processor may acquire a hash code by performing a hash operation on a task state of the sequence data, generate an information vector by encoding a task action and a task of the sequence data, and generate the training data based on the hash code and the information vector.

The processor may acquire a one-hot vector as the information vector by performing one-hot encoding on the task action and the task.

The processor may determine an edge connected to a front node in the search tree based on the recommended path, and determine a child node connected to the edge based on the edge.

The processor may determine a recommended action type among the plurality of task actions based on the recommended path, and determine the edge based on the recommended action type.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a block diagram illustrating a task plan generation apparatus according to an example embodiment;

FIG. 2 illustrates an example of a task and a task plan;

FIG. 3A illustrates an example of a task state according to the task of FIG. 2;

FIG. 3B illustrates an example of a state transition path according to the task of FIG. 2;

FIG. 3C illustrates an example of a search tree according to the task of FIG. 2;

FIG. 4 illustrates an example of a neural network used by the task plan generation apparatus of FIG. 1;

FIG. 5 illustrates another example of a neural network used by the task plan generation apparatus of FIG. 1;

FIG. 6 illustrates another example of a task and a task plan;

FIG. 7 illustrates an example of sequence data according to a task state, a task action, and a task;

FIG. 8 illustrates an example of an action type in a task plan;

FIG. 9 illustrates an operation of expanding a node in a search tree; and

FIG. 10 is a flowchart illustrating an operation of the task plan generation apparatus of FIG. 1.

### DETAILED DESCRIPTION

The following structural or functional descriptions of example embodiments described herein are merely intended for the purpose of describing the example embodiments described herein and may be implemented in various forms. Here, the example embodiments are not construed as limited to the disclosure and should be understood to include all changes, equivalents, and replacements within the idea and the technical scope of the disclosure.

Although terms of “first,” “second,” and the like are used to explain various components, the components are not limited to such terms. These terms are used only to distinguish one component from another component. For example, a first component may be referred to as a second component, or similarly, the second component may be referred to as the first component within the scope of the present disclosure.

When it is mentioned that one component is “connected” or “accessed” to another component, it may be understood that the one component is directly connected or accessed to another component or that still other component is interposed between the two components.

As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, components or a combination thereof, but do not preclude the presence or addition of one or more other features, integers, steps, operations, elements, components, and/or groups thereof

Unless otherwise defined herein, all terms used herein including technical or scientific terms have the same meanings as those generally understood by one of ordinary skill in the art. Terms defined in dictionaries generally used should be construed to have meanings matching contextual meanings in the related art and are not to be construed as an ideal or excessively formal meaning unless otherwise defined herein.

Hereinafter, example embodiments will be described in detail with reference to the accompanying drawings. When describing the example embodiments with reference to the accompanying drawings, like reference numerals refer to like components and a repeated description related thereto will be omitted.

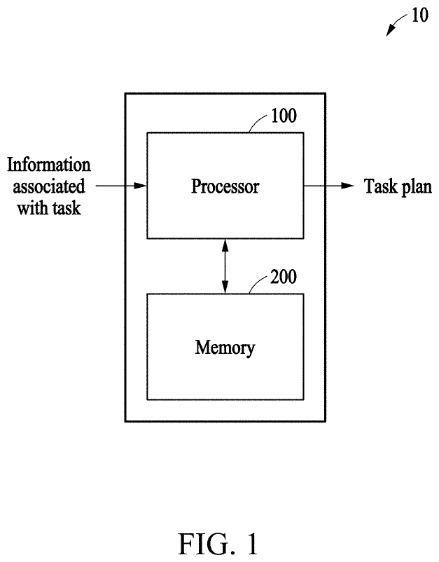

FIG. 1 is a block diagram illustrating a task plan generation apparatus according to an example embodiment.

Referring to FIG. 1, a task plan generation apparatus 10 may generate a task plan for performing an arbitrary task. The task plan generation apparatus 10 may process information associated with a task to generate the task plan.

The task may be a series of physical behaviors performed by an autonomous thing. For example, the autonomous thing may include a robot or an autonomous vehicle.

The task plan generation apparatus 10 may generate a search tree associated with the task, and generate the task plan based on the search tree.

The task plan generation apparatus 10 may generate the task plan by using a neural network. The task plan generation apparatus 10 may predict a path capable of achieving the task plan in the search tree by using the neural network, thereby generating an efficient task plan.

The neural network (or an artificial neural network) may include a statistical training algorithm that mimics a biological nerve in machine training and cognitive science. The neural network may refer to a general model that has the ability to solve a problem, where artificial neurons (nodes) forming the network through synaptic combinations change a connection strength of synapses through training.

A neuron of the neural network may include a combination of weights or biases. The neural network may include one or more layers, each including one or more neurons or nodes. The neural network may infer a result to be predicted from an arbitrary input by changing a weight of the neuron through the training.

The neural network may include a deep neural network (DNN). The neural network may include a convolutional neural network (CNN), a recurrent neural network (RNN), a perceptron, a multilayer perceptron, a feed forward (FF), a radial basis function (RBF) network, a deep feed forward (DFF), a long short term memory (LSTM), a gated recurrent unit (GRU), an auto encoder (AE), a variational auto encoder (VAE), a denoising auto encoder (DAE), a sparse auto encoder (SAE), a markov chain (MC), a hopfield network (HN), a boltzmann machine (BM), a restricted boltzmann machine (RBM), a deep belief network (DBN), a deep convolutional network (DCN), a deconvolutional network (DN), a deep convolutional inverse graphics network (DCIGN), a generative adversarial network (GAN), a liquid state machine (LSM), an extreme learning machine (ELM), an echo state network (ESN), a deep residual network (DRN), a differentiable neural computer (DNC), a neural turning machine (NTM), a capsule network (CN), a kohonen network (KN), and an attention network (AN).

The task plan generation apparatus 10 may be implemented within a personal computer (PC), a data server or a portable device.

The portable device may be implemented as a laptop computer, a mobile phone, a smartphone, a tablet PC, a mobile interne device (MID), a personal digital assistant (PDA), an enterprise digital assistant (EDA), a digital still camera, a digital video camera, a portable multimedia player (PMP), a personal navigation device or a portable navigation device (PND), a handheld game console, an e-book, or a smart device. The smart device may be implemented as a smart watch, a smart band, or a smart ring.

The task plan generation apparatus 10 may include a processor 100 and a memory 200.

The processor 100 may process data stored in the memory 200. The processor 100 may execute a computer-readable code (e.g., software) stored in the memory 200, and instructions triggered by the processor 100.

The processor 100 may be a hardware-implemented data processing device having a circuit that is physically structured to execute desired operations. For example, the desired operations may include codes or instructions included in a program.

For example, the hardware-implemented data processing device may include a microprocessor, a central processing unit (CPU), a processor core, a multi-core processor, a multiprocessor, an application-specific integrated circuit (ASIC), and a field-programmable gate array (FPGA).

The processor 100 may generate a search tree based on a plurality of task states of a task and a plurality of task actions for performing the task.

A task state may be a shape or a circumstance of which an object involved in the task is placed, which may be observed while the task is performed. The object involved in the task may include a target on which the task is to be performed and a subject performing the task. A task action may be an operation by which subjects performing the task perform the task.

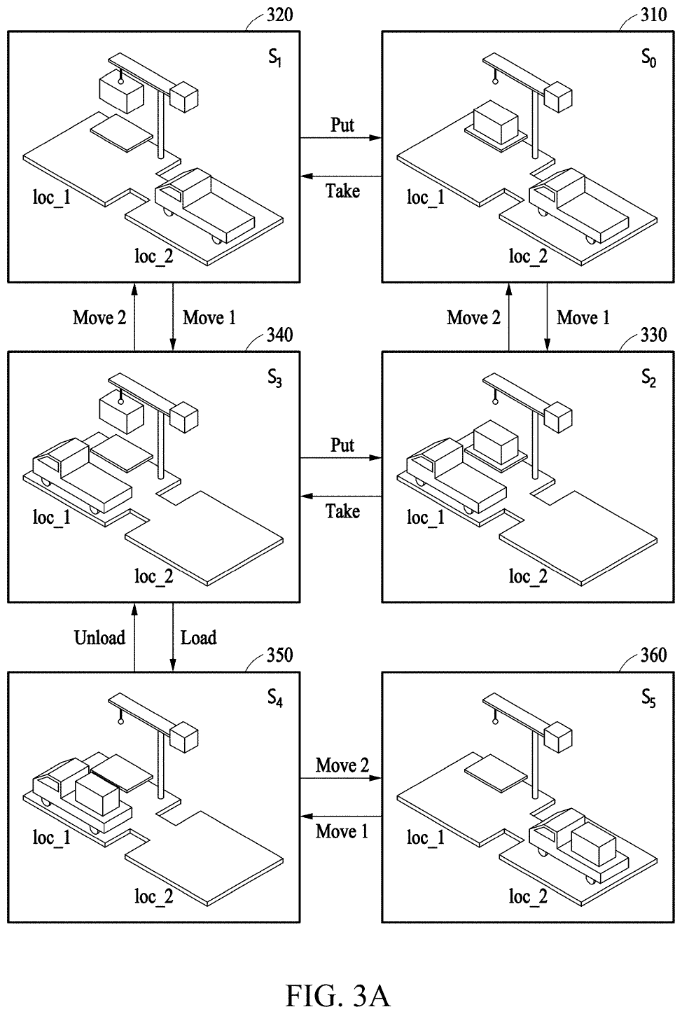

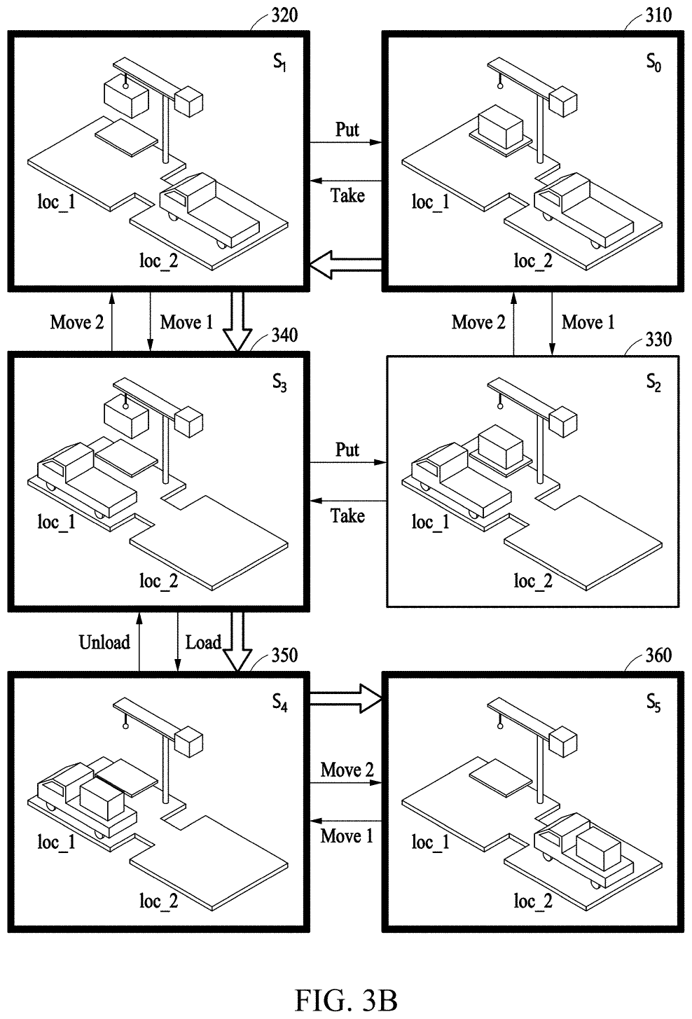

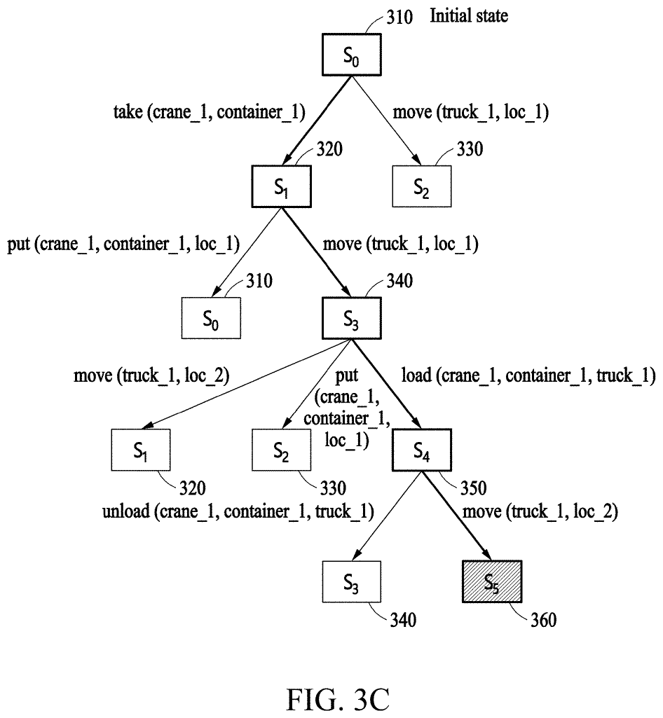

The search tree may be a set of figures indicative of a process of a task in progress by representing a task state as a node and representing a task action as an edge. The processor 100 may generate nodes corresponding to the plurality of task states, and generate the search tree by connecting the nodes via edges corresponding to the plurality of task actions. A process of generating the search tree will be described in detail with reference to FIGS. 3A through 3C.

The processor 100 may estimate a recommended path for an internal connection of the search tree by inputting the plurality of task states and the plurality of task actions to the neural network based on the search tree. The processor 100 may generate a trained neural network by training the neural network based on the plurality of task states and the plurality of task actions.

The processor 100 may generate a temporary task plan based on heuristics. The processor 100 may generate the trained neural network by training the neural network based on the temporary task plan, the plurality of task states, and the plurality of task actions.

The processor 100 may estimate the recommended path based on the trained neural network. The processor 100 may generate sequence data based on the plurality of task states, the plurality of task actions, and the task. The processor 100 may generate training data of the neural network by converting the sequence data.

The processor 100 may acquire a hash code by performing a hash operation on a task state of the sequence data. The processor 100 may generate an information vector by encoding a task action and a task of the sequence data. The processor 100 may acquire a one-hot vector as the information vector by performing one-hot encoding on the task action and the task.

The processor 100 may generate the training data based on the hash code and the information vector.

The processor 100 may generate the task plan by determining a target path that reaches from an initial state of the task to a target state of the task based on the recommended path. The processor 100 may determine an edge connected to a front node in the search tree based on the recommended path.

The processor 100 may determine a recommended action type among the plurality of task actions based on the recommended path. The processor 100 may determine the edge based on the recommended action type. The processor 100 may determine a child node connected to the edge based on the edge.

The memory 200 may store instructions (or programs) that are executable by the processor 100. For example, the instructions may include instructions for executing an operation of the processor and/or an operation of each element of the processor.

The memory 200 may be implemented as a volatile memory device or a non-volatile memory device.

The volatile memory device may be implemented as a dynamic random-access memory (DRAM), a static random-access memory (SRAM), a thyristor RAM (T-RAM), a zero capacitor RAM (Z-RAM), or a twin transistor RAM (TTRAM).

The non-volatile memory device may be implemented as an electrically erasable programmable read-only memory (EEPROM), a flash memory, a magnetic RAM (MRAM), a spin-transfer torque (STT)-MRAM, a conductive bridging RAM (CBRAM), ferroelectric RAM (FeRAM), a phase change RAM (PRAM), a resistive RAM (RRAM), a nanotube RRAM, a polymer RAM (PoRAM), a nano floating gate memory (NFGM), a holographic memory, a molecular electronic memory device, or an insulator resistance change memory.

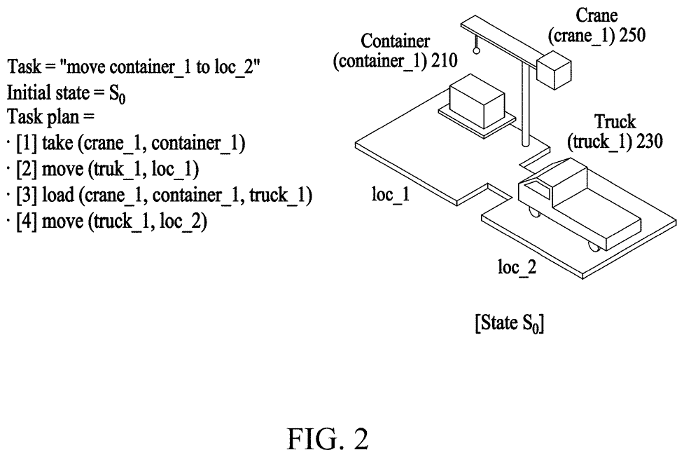

FIG. 2 illustrates an example of a task and a task plan.

Referring to FIG. 2, a task plan generation apparatus (e.g., the task plan generation apparatus 10 of FIG. 1) may be implemented in an autonomous thing that performs a task. The task plan generation apparatus 10 may include a cognitive system and a behavior system for performing the task.

The cognitive system may continue to percept a surrounding environment of the task plan generation apparatus 10, and the behavior system may deterministically execute a determined (or called) action.

A processor (e.g., the processor 10 of FIG. 1) may generate a task plan for performing an arbitrary task. The task plan may include a task state and a task action that changes the task state. The task action may be a unit operation that changes a task state (e.g., an environment state). The task plan may be a state transition path from an initial state to a target state in a state space that includes all possible states of the task state (e.g., the environment state) and a transition between the states.

An example of FIG. 2 may represent a brief task environment, a current task state (an initial state (e.g., S₀)), a given task, and a task plan for the given task using symbols.

In the example of FIG. 2, the task may be a task of moving a container 210 (e.g., container_1) to a specific place (e.g., loc_2). FIG. 2 illustrates an initial state before the task is started. The processor 100 may use a crane 250 (e.g., crane_1) to move the container 210 (e.g., container_1) on a truck 230 (e.g., truck_1) by generating the task plan. Such a task plan may include a plurality of task actions. A first task action may be an action of using the crane 250 to lift the container 210. A second task action may be an action of moving the truck 230 to a first location (e.g., loc_1). A third task action may be an action of using the crane 250 to load the container 210 on the truck 230. A fourth task action may be an action of moving a truck to a second location (e.g., loc_2).

FIG. 3A illustrates an example of a task state according to the task of FIG. 2, FIG. 3B illustrates an example of a state space transition path according to the task of FIG. 2, and FIG. 3C illustrates an example of a search tree according to the task of FIG. 2.

Referring to FIGS. 3A through 3C, a processor (e.g., the processor 100 of FIG. 1) may perform a task on an object to be a target for the task via a series of task actions of FIG. 2.

The task plan may include a state space transition path having a sequence of a task state that changes according to the task action. The processor 100 may efficiently predict the state space transition path by using the search tree.

FIG. 3A illustrates examples of a task state that may occur in the example of FIG. 2. A task state 310 may be an initial state. A task state 320 may be a state in which a crane takes a container and a truck is placed in the second location (e.g., loc_2). The task states 310 and 320 may transit to each other via a task action that the crane lifts and puts down the container.

A task state 330 may be a state in which the truck moves from the second location (e.g., loc_2) to the first location (e.g., loc_1). The task states 330 and 320 may transit to each other via a task action that the truck is moved.

A task state 340 may transition from the task state 320 via a task action that the truck is moved. Alternatively, the task state 340 may transition from the task state 330 via a task action that the crane lifts the container.

A task state 350 may transition from the task state 340 via a task action that the crane loads the container on the truck. A task state 360 may transition from the task state 350 via a task action that the truck is moved. An example of FIG. 3B may be an operation of generating the state space transition path that reaches from the initial state to the target state by connecting the task states of FIG. 3A to the task actions. The processor 100 may generate the task plan by searching for an optimal state space transition path using the search tree.

The processor 100 may generate the task plan by determining a target path (or, a target state space transition path) from an initial state (e.g., the task state 310) to a target state (e.g., the task state 360).

The processor 100 may determine the target path using a neural network. The processor 100 may train the neural network, and determine the target path by using the trained neural network.

The processor 100 may generate the search tree by expanding related nodes in order from a node representing a current task state to a node corresponding to the target state.

The processor 100 may determine the target path in the search tree by efficiently selecting an expansion node for reaching a target node corresponding to the target state by using the neural network.

The processor 100 may determine the edge connected to the front node of the search tree based on the recommended path estimated by the neural network, and determine the child node connected to the edge based on the edge. The front node may be a node having no lower node or child node. The front node may be a candidate point where the search tree is expanded by connecting the edge in a next process of path search.

The processor 100 may estimate a distance to the target node by using the heuristic or a heuristic search in a process of generating an initial search tree.

The heuristic search may be a scheme of estimating a distance from the front node to a node (e.g., the target node) corresponding to the target state and selecting a node having a short distance as a node to be expanded in a next operation. A process of estimating a path may be referred to as “heuristic”.

The processor 100 may save time and resources required for estimating a path from various domains to a target node. The processor 100 may train the neural network, and estimate an optimal path by using the trained neural network, thereby quickly searching for a path (e.g., a target path) from a node corresponding to an initial state to a node corresponding to a target state, with a fewer resources.

The processor 100 may search for the optimal path with relatively high performance in comparison to the simple heuristic by estimating an edge having a high possibility of being connected to the target node among edges connected to an arbitrary node. The processor 100 may select an edge having a high possibility of being connected to a node having a superior estimated value (e.g., a low estimated value) for edges connected to an expandable lower node, instead of searching for all possible edges from all front nodes, to efficiently search for a path.

The processor 100 may maintain a size of a front node set to be relatively small in comparison to a heuristic scheme, by adding “n” nodes connected to “n” edges (e.g., n is a natural number) estimated by the neural network among lower nodes to the front node set. The processor 100 may search for a path that reaches to the target node by using a minimum heuristic by excluding a node with a low possibility of being connected to a target node, thereby reducing time and resources required for generating the task plan.

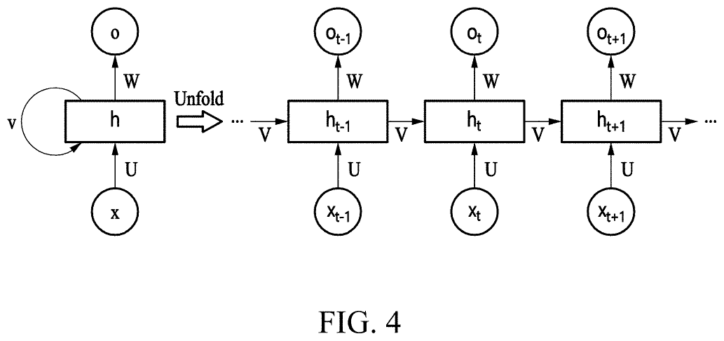

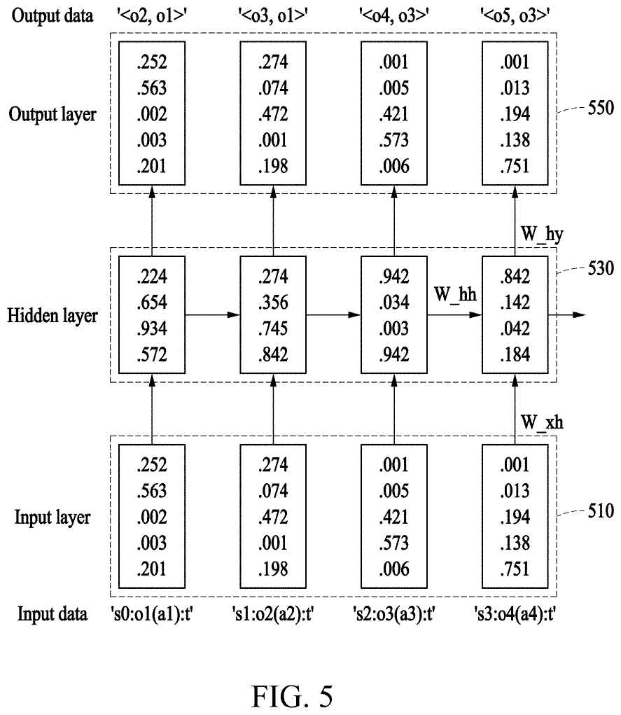

FIGS. 4 and 5 illustrate examples of a neural network used by the task plan generation apparatus of FIG. 1.

Referring to FIGS. 4 and 5, a processor (e.g., the processor 100 of FIG. 1) may estimate a recommended path for an internal connection of a search tree by inputting a plurality of task states and a plurality of task actions to a neural network based on the search tree.

The processor 100 may estimate the recommended path by training a task pattern by using the neural network (e.g., an RNN). The task pattern may be a pattern having a sequence of task actions of a task plan in an arbitrary domain.

Considering a task environment where a plurality of cranes, a plurality of trucks and a plurality of containers are present based on the example of FIG. 2, a container to be moved, a truck used for moving the container, and a crane used for loading and unloading the container may be determined according to circumstances. However, a container transfer task may have a common pattern in an abstract level. The container transfer task may have a task pattern having an order of moving a truck, loading a container by a crane, moving the truck, and unloading the container by the crane.

For example, in an individual task plan included in tasks such as “Transfer a first cargo to a first location” or “Transfer a second cargo to a second location”, the task pattern may be in a form of a sequential pattern of, for example, subtracting a first operation of moving the truck if an empty truck is present near a cargo or a crane, or embodying an operation of moving a first truck if a currently available truck is the first truck. The processor 100 may recommend an edge corresponding to a task action that may be proceeded from a node corresponding to a current task state by using the task pattern.

The processor 100 may train the neural network based on the task pattern (e.g., the sequential pattern) by using an example including an order as training data. The processor 100 may classify or predict the sequence data via the neural network that is trained on the task pattern. The sequence data may be data given as a group including an order in each element. For example, the sequence data may include voice, video or text that has an order. A length of the sequence may be variable.

The neural network may include an input layer 510, a hidden layer 530 and an output layer 550. The processor 100 may predict (t+1)^{th} output data by using the neural network when t^{th} data of the sequence data is given. When the t^{th} data is xₜ and output data to be predicted is oₜ, the processor 100 may predict output sequence data o₁, o₂, . . . , oₜ from input sequence data x₁, x₂, . . . , xₜ.

For example, when the sequence data is a sentence, numerous combinations of multiple words may be possible because the sentence is an ordered set of words. However, in actual, each word may be strongly affected by a sequence of a preceding word. A sentence with an accurate meaning used by human may have context having a dependency relationship between words.

The neural network (e.g., the RNN) may have a cyclic path having a direction therein, temporarily memorize information, and dynamically change a reaction according to the memorized information and the cyclic path. The processor 100 may catch context present in the sequence data using the neural network, and determine output data by simultaneously taking into consideration previously input data and currently input data based on the context.

To generate the task plan, the processor 100 may generate the sequence data of the task state, the task action, and the task. The processor 100 may input the sequence data in a form of “task state:task action:task” to the neural network in order, and output one task action or a plurality of task actions in a corresponding time operation. In the example of FIG. 5, s₀ through s₃ may represent task states, o₁ through o₄ may represent task actions, and t may represent a task.

The processor 100 may generate data (e.g., training data) to be input to the input layer 510 of the neural network by converting the sequence data. The processor 100 may acquire a hash code by performing a hash operation on the task state of the sequence data, and generate an information vector by encoding the task action and the task of the sequence data. The processor 100 may generate the data to be input to the input layer 510, based on the hash code and the information vector.

The processor 100 may generate the sequence data in the form of “task state:task action:task” by adding task information to a unit of information of “task state:task action”. The processor 100 may generate the data (e.g., the training data) to be input to the input layer 510 by converting the generated sequence data.

A node or task state information may correspond to a set (e.g., a set of statements such as “container_1 is located in loc_1”) of symbolic logical statements describing a task environment.

Here, since a large number of symbols are included in a statement, the processor 100 may convert the task state information to a single number and store the number, to reduce a number of symbols and facilitate training of the neural network. The symbolic logical statement may correspond to a set of strings, and the processor 100 may generate a numerical value corresponding to the task state by using a string hash code generation function provided in a programming language.

A unit of information of “task state:task action:task” may be configured with symbols other than state information stored as a hash code. The processor 100 may generate an information vector to process the sequence data by using the neural network, and generate an ordered set by collecting vectors. For example, the processor 100 may generate an information element of “task state:task action:task” as an information vector by performing one-hot encoding on symbols, and may generate the ordered set by collecting information vectors. The training data may have a form of an ordered set.

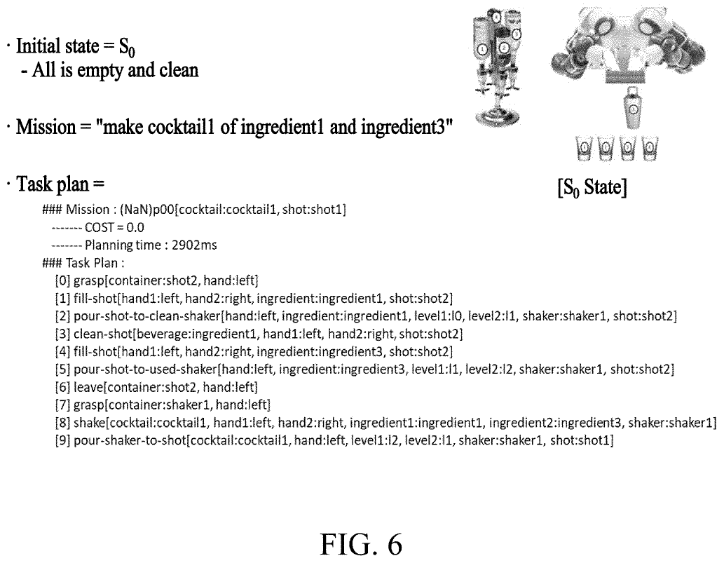

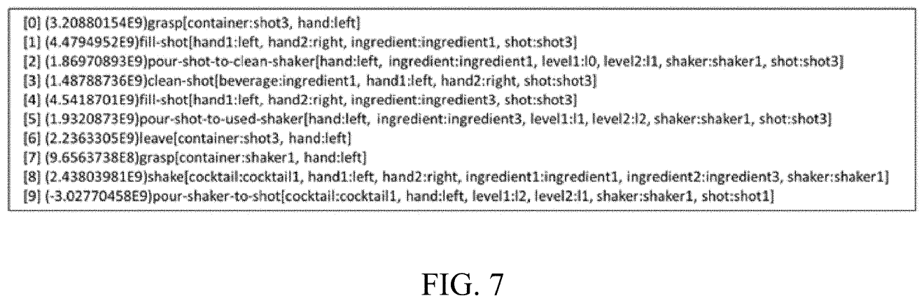

FIG. 6 illustrates another example of a task and a task plan, and FIG. 7 illustrates an example of sequence data according to a task state, a task action, and a task.

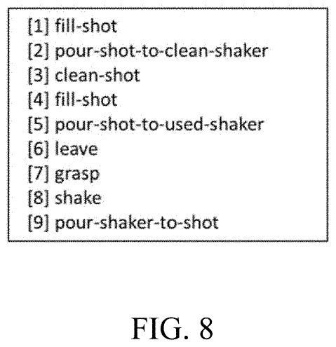

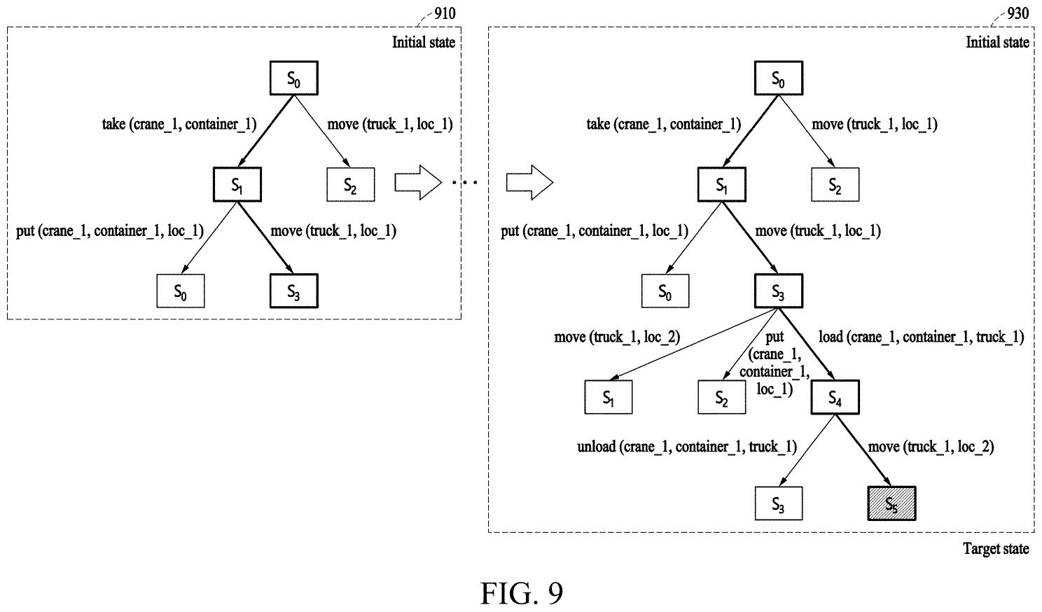

FIG. 8 illustrates an example of an action type in a task plan, and FIG. 9 illustrates an operation of expanding a node in a search tree.

Referring to FIGS. 6 through 9, FIG. 6 illustrates a task plan for a task of preparing a cocktail by using a bartender robot. FIG. 6 illustrates examples of a task environment, a task and a task plan of a robot domain.

The processor 100 of FIG. 1 may generate an illustrated task action, and the task plan for reaching from an initial state (e.g., s₀) to a target state (e.g., a completion of a cocktail) based on the task action.

The processor 100 may generate a search tree based on a heuristic, and generate a task plan by using the search tree. As described above, the generated task plan may include information on a task state expressed by a node in a detailed search tree and on a detained action expressed by an edge in the search tree, and include information on an order of a task state and an action (e.g., task state 1:task action 1, or task state 2:task action 2).

The processor 100 may add task information to received order information, and another information set of “a task plan+a task” which is previously stored, and may store the information in a memory 300. The processor 100 may train the neural network by converting a set of all information “a task plan+a task” to task pattern training data. The converting of the training data may be the same as those described with reference to FIGS. 4 and 5.

The processor 100 may train the neural network based on the training data, and generate a recommended path based on the trained neural network or generate a recommended node based on the recommended path. The processor 100 may predict a type of an edge having a high possibility of being connected to a lower node with a high estimated value (e.g., a lower node that may reach a target state as quickly as possible) and a current node.

The processor 100 may determine the task action by recommending a detailed action type. For example, the detailed task action may be expressed by “action name+parameter value sequence” such as “load(crane_1, container_1, truck_1)”. Here, the action name may be an action type.

The processor 100 may search for a target path based on a recommended result of the action type. When the processor 100 expands each node during a search of a path, an action type corresponding to an edge may be or not be recommended from the neural network.

If the action type is not recommended, the processor 100 may add all child nodes of a front node that is determined to be expanded by using a heuristic, to a front node set. That is, if the action type is not recommended, a task plan may be generated only by using the heuristic.

If the action type is recommended, the processor 100 may add a node connected to an edge corresponding to the recommended action type among lower nodes of the node to be expanded, to the front node set.

The processor 100 may add information on a node where the edge starts or on the task state, to each task action (edge) information such as “load(crane_1, container_1, truck_1)” that is found during a process of configuring the search tree to generate a unit of information of “task state:task action” of the task plan.

If a trained neural network is not generated, or if an accuracy of the trained neural network does not reach a predetermined threshold, the processor 100 may not recommend an action type.

Since no task plan is generated when the processor 100 initially generates a task plan, training data may not be generated. The processor 100 may generate a task plan and accumulate the task plan such that the neural network may train a task pattern, thereby increasing task plan generation performance.

The processor 100 may evaluate a prediction accuracy of the trained neural network by dividing a portion of the generated training data into test data.

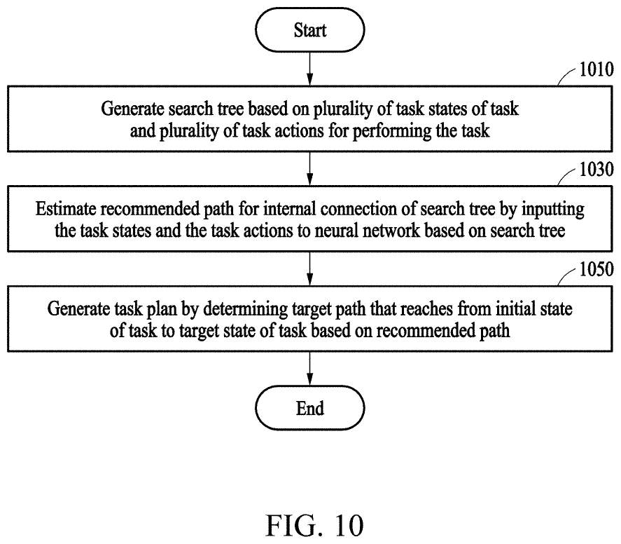

FIG. 10 is a flowchart illustrating an operation of the task plan generation apparatus of FIG. 1.

Referring to FIG. 10, in operation 1010, a processor (e.g., the processor 100 of FIG. 1) may generate a search tree based on a plurality of task states of a task and a plurality of task actions for performing a task.

The processor 100 may generate nodes corresponding to the plurality of task states, and generate the search tree by connecting the nodes via edges corresponding to the plurality of task actions.

In operation 1030, the processor 100 may estimate a recommended path for an internal connection of the search tree by inputting the plurality of task states and the plurality of task actions to a neural network based on the search tree.

The processor 100 may generate a trained neural network by training the neural network based on the plurality of task states and the plurality of task actions. The processor 100 may generate a temporary task plan based on a heuristics. The processor 100 may generate the trained neural network by training the neural network based on the temporary task plan, the plurality of task states, and the plurality of task actions.

The processor 100 may estimate the recommended path based on the trained neural network. The processor 100 may generate sequence data based on the plurality of task states, the plurality of task actions, and the task. The processor 100 may generate training data of the neural network by converting the sequence data.

The processor 100 may acquire a hash code by performing a hash operation on a task state of the sequence data. The processor 100 may generate an information vector by encoding a task action and a task of the sequence data. The processor 100 may generate the training data based on the hash code and the information vector. The processor 100 may acquire a one-hot vector as an information vector by performing one-hot encoding on the task action and the task.

In operation 1050, the processor 100 may generate a task plan by determining a target path that reaches from an initial state of the task to a target state of the task based on the recommended path.

The processor 100 may determine an edge connected to a front node in the search tree based on the recommended path. The processor 100 may determine a recommended action type among the plurality of task actions based on the recommended path. The processor 100 may determine an edge based on the recommended action type. The processor 100 may determine a child node connected to the edge based on the edge.

The components described in the example embodiments may be implemented by hardware components including, for example, at least one digital signal processor (DSP), a processor, a controller, an ASIC, a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The example embodiments described herein may be implemented using hardware components, software components, or a combination thereof. A processing device may be implemented using one or more general-purpose or special purpose computers, such as, for example, a processor, a controller and an arithmetic logic unit, a digital signal processor, a microcomputer, a field programmable gate array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums.

The method according to the above-described example embodiments may be recorded in non-transitory computer-readable media including program instructions to implement various operations which may be performed by a computer. The media may also include, alone or in combination with the program instructions, data files, data structures, and the like. The program instructions recorded on the media may be those specially designed and constructed for the purposes of the example embodiments, or they may be of the well-known kind and available to those having skill in the computer software arts. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. The media may be transfer media such as optical lines, metal lines, or waveguides including a carrier wave for transmitting a signal designating the program command and the data construction. Examples of program instructions include both machine code, such as code produced by a compiler, and files containing higher level code that may be executed by the computer using an interpreter.

The described hardware devices may be configured to act as one or more software modules in order to perform the operations of the above-described example embodiments, or vice versa.

While this disclosure includes example embodiments, it will be apparent to one of ordinary skill in the art that various changes in form and details may be made in these example embodiments without departing from the spirit and scope of the claims and their equivalents. The example embodiments described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

What is claimed is:

1. A method of generating a task plan for performing an arbitrary task, the method comprising:
generating a search tree based on a plurality of task states of the task and a plurality of task actions for performing the task;
estimating a recommended path for an internal connection of the search tree by inputting the plurality of task states and the plurality of task actions to a neural network based on the search tree; and
generating the task plan by determining a target path that reaches from an initial state of the task to a target state of the task based on the recommended path.

2. The method of claim 1, wherein the generating of the search tree comprises:
generating nodes corresponding to the plurality of task states; and
generating the search tree by connecting the nodes via edges corresponding to the plurality of task actions.

3. The method of claim 1, wherein the estimating of the recommended path comprises:
generating a trained neural network by training the neural network based on the plurality of task states and the plurality of task actions; and
estimating the recommended path based on the trained neural network.

4. The method of claim 3, wherein the generating of the trained neural network comprises:
generating a temporary task plan based on a heuristics; and
generating the trained neural network by training the neural network based on the temporary task plan, the plurality of task states, and the plurality of task actions.

5. The method of claim 3, wherein the estimating of the recommended path comprises:
generating sequence data based on the plurality of task states, the plurality of task actions, and the task; and
generating training data of the neural network by converting the sequence data.

6. The method of claim 5, wherein the generating of the training data comprises:
acquiring a hash code by performing a hash operation on a task state of the sequence data;
generating an information vector by encoding a task action and a task of the sequence data; and
generating the training data based on the hash code and the information vector.

7. The method of claim 6, wherein the generating of the information vector comprises acquiring a one-hot vector as the information vector by performing one-hot encoding on the task action and the task.

8. The method of claim 1, wherein the generating of the task plan comprises:
determining an edge connected to a front node in the search tree based on the recommended path; and
determining a child node connected to the edge based on the edge.

9. The method of claim 8, wherein the determining of the edge comprises:
determining a recommended action type among the plurality of task actions based on the recommended path; and
determining the edge based on the recommended action type.

10. A non-transitory computer-readable storage medium storing instructions that, when executed by a processor, cause the processor to perform the method of claim 1.

11. An apparatus for generating a task plan for performing an arbitrary task, the apparatus comprising:
a processor configured to generate a search tree based on a plurality of task states of the task and a plurality of task actions for performing the task, estimate a recommended path for an internal connection of the search tree by inputting the plurality of task states and the plurality of task actions to a neural network based on the search tree, and generate the task plan by determining a target path that reaches from an initial state of the task to a target state of the task based on the recommended path; and
a memory configured to store an instruction that is executable by the processor.

12. The apparatus of claim 11, wherein the processor is configured to generate nodes corresponding to the plurality of task states, and generate the search tree by connecting the nodes via edges corresponding to the plurality of task actions.

13. The apparatus of claim 11, wherein the processor is configured to generate a trained neural network by training the neural network based on the plurality of task states and the plurality of task actions, and estimate the recommended path based on the trained neural network.

14. The apparatus of claim 13, wherein the process is configured to generate a temporary task plan based on a heuristics, and generate the trained neural network by training the neural network based on the temporary task plan, the plurality of task states and the plurality of task actions.

15. The apparatus of claim 13, wherein the processor is configured to generate sequence data based on the plurality of task states, the plurality of task actions, and the task, and generate training data of the neural network by converting the sequence data.

16. The apparatus of claim 15, wherein the processor is configured to acquire a hash code by performing a hash operation on a task state of the sequence data, generate an information vector by encoding a task action and a task of the sequence data, and generate the training data based on the hash code and the information vector.

17. The apparatus of claim 16, wherein the process is configured to acquire a one-hot vector as the information vector by performing one-hot encoding on the task action and the task.

18. The apparatus of claim 11, wherein the processor is configured to determine an edge connected to a front node in the search tree based on the recommended path, and determine a child node connected to the edge based on the edge.

19. The apparatus of claim 18, wherein the processor is configured to determine a recommended action type among the plurality of task actions based on the recommended path, and determine the edge based on the recommended action type.
